(19) United States
(12) Patent Application Publication
(10) Pub. No.: US 2025/0285169 A1
(43) Pub. Date: Sep. 11, 2025

(54) DIGITAL ASSET FACTORY

(71) Applicant: Concentrix CVG Customer Management Delaware LLC, Cincinnati, OH (US)

(72) Inventors: Shawn Patrick Ennis, Frisco, TX (US); Varun Vipul Lashkari, Ann Arbor, MI (US); Kranthi Kumar Bitra, Hyderabad (IN)

(21) Appl. No.: 18/859,581

(22) PCT Filed: May 17, 2023
(86) PCT No.: PCT/US2023/022508

§ 371 Date: Oct. 24, 2024

(30) Foreign Application Priority Data
May 18, 2022 (IN) 202211028626

(51) Int. Cl. G06Q 30/0601; G06Q 30/0201

(52) U.S. Cl. CPC G06Q 30/0641; G06Q 30/0206; G06Q 30/0627; G06Q 2220/00

(57) ABSTRACT

Systems and methods for generating and minting digital assets can include one or more user interfaces configured to receive data associated with a digital asset type, a quantity to mint, a cost limit, and a variety of other data. The systems and methods can leverage the received data to generate and mint one or more non-fungible tokens for the digital asset. The systems and methods can include cost control validation to ensure the cost limit is not exceeded. The systems and methods may utilize one or more template data files from a database based on the digital asset type.

### RELATED APPLICATIONS

This application claims priority to and the benefit of Indian Provisional Patent Application No. 202211028626, filed May 18, 2022. Indian Provisional Patent Application No. 202211028626 is hereby incorporated by reference in its entirety.

### FIELD

The present disclosure relates generally to providing a platform for designing and minting digital assets. More particularly, the present disclosure relates to generating one or more non-fungible tokens to be registered on a specific blockchain based at least in part on one or more inputs from a user.

### BACKGROUND

The market for non-fungible tokens has grown greatly in recent years. Additionally, the emergence of Web3 and the emergence of digital lifestyles may indicate further growth of the market in the future. However, there can be some accessibility issues for designing and minting the non-fungible tokens. Lack of knowledge related to blockchain scripts can inhibit some creators from entering the market. Additionally, the minting process can be non-intuitive and different from any other process that a company may normally partake in for commerce.

### SUMMARY

Aspects and advantages of embodiments of the present disclosure will be set forth in part in the following description, or can be learned from the description, or can be learned through practice of the embodiments.

One example aspect of the present disclosure is directed to a computing system for requesting digital asset generation. The system can include one or more processor and one or more non-transitory computer-readable media that collectively store instructions that, when executed by the one or more processors, cause the computing system to perform operations. The operations can include providing an order graphical user interface. The order graphical user interface can include a plurality of entry fields. The operations can include receiving, via the order graphical user interface, a minting request. In some implementations, the minting request can include input data input into one or more of the plurality of entry fields. The input data can be descriptive of a digital asset, a quantity, a specific blockchain of a plurality of blockchains, and a cost limit. In some implementations, the cost limit can be descriptive a maximum cost threshold. The operations can include determining a mint cost based at least in part on the quantity and the specific blockchain and determining the mint cost is below the maximum cost threshold. The operations can include generating one or more tokens. The token can include a script that is descriptive of a storage location for the digital asset. The operations can include adding the one or more tokens to the specific blockchain. In response to adding the one or more tokens to the specific blockchain, the operations can include obtaining one or more contract addresses associated with the one or more tokens. The operations can include providing the one or more contract addresses.

In some implementations, the operations can include providing an initial user interface. The initial user interface can be configured to receive one or more inputs associated with designing the digital asset. The operations can include receiving a product type input. The product type input can include a product type selection associated with a particular product type of a plurality of product types. In some implementations, the operations can include updating the initial user interface based on the product type input and generating one or more data files based on the particular product type. The one or more data files can include a text file and an image file. In some implementations, the digital asset can include at least one of an authentication certificate, an augmented-reality rendering asset, or a virtual-reality asset. The plurality of entry fields can include a blockchain entry field. The blockchain entry field can be configured to receive one or more inputs from the user descriptive of the specific blockchain of the plurality of blockchains. In some implementations, the plurality of entry fields can include a product entry field. The product entry field can be configured to receive one or more inputs from the user descriptive of the digital asset. The plurality of entry fields can include a quantity entry field. The quantity entry field can be configured to receive one or more inputs from the user descriptive of the quantity.

Another example aspect of the present disclosure is directed to a computer-implemented method for minting digital assets. The method can include obtaining, via an order graphical user interface and by a computing system including one or more processors, input data. In some implementations, the input data can be descriptive of a digital asset, a specific blockchain of a plurality of blockchains, and a cost limit. The method can include determining, by the computing system, a mint cost based at least in part on the specific blockchain. The mint cost can be descriptive of a cost to put a token on the specific blockchain. The method can include determining, by the computing system, the mint cost is below a maximum cost threshold. In some implementations, the maximum cost threshold can be associated with the cost limit. The method can include generating, by the computing system, a token. The token can be associated with the digital asset. The method can include recording, by the computing system, the token on the specific blockchain and providing, by the computing system, the digital asset with a contract address. In some implementations, the contract address can be associated with the token.

In some implementations, the input data can include quantity data. The quantity data can be descriptive of a specific number of non-fungible tokens to mint. The mint cost can be determined based on the quantity data, the specific blockchain, and a predicted gas fee. In some implementations, the token can be a non-fungible token. The token can include a script referencing the digital asset. The digital asset can be associated with loyalty rewards of a loyalty program associated with a specific company. In some implementations, the digital asset can include an authentication certificate. The authentication certificate can be generated based at least in part on a serial number for a particular physical product.

Another example aspect of the present disclosure is directed to one or more non-transitory computer-readable media that collectively store instructions that, when executed by one or more computing devices, cause the one or more computing devices to perform operations. The operations can include providing an initial user interface. The initial user interface can include a catalog of different asset types. The operations can include obtaining, via the initial user interface, a selection of a particular asset type from the catalog of different asset types. The operations can include obtaining one or more template data files based on the selection. In some implementations, the one or more template data files can be associated with the particular asset type. The operations can include receiving a minting request. The minting request can include input data input into an order graphical user interface. In some implementations, the input data can be descriptive of a digital asset, a quantity, and a specific blockchain of a plurality of blockchains. The operations can include generating one or more tokens based at least in part on the one or more template data files and the input data. The token can include a script that is descriptive of a storage location for the digital asset. The operations can include adding the one or more tokens to the specific blockchain. The operations can include obtaining one or more contract addresses associated with the one or more tokens in response to adding the one or more tokens to the specific blockchain. The operations can include providing the one or more contract addresses.

In some implementations, the input data can include a cost limit. The cost limit can be descriptive a maximum cost threshold. The operations can include determining a mint cost based at least in part on the quantity and the specific blockchain and determining the mint cost is below the maximum cost threshold. The one or more tokens can be generated in response to the mint cost being below the maximum cost threshold. The input data can include a cost limit. The cost limit can be descriptive a maximum cost threshold. The operations can include determining a mint cost based at least in part on the quantity and the specific blockchain, determining the mint cost is above the maximum cost threshold, generating an error notification based on the mint cost being above the maximum cost threshold, and providing, via the order graphical user interface, the error notification. In some implementations, the digital asset can include an augmented-reality rendering asset. The augmented-reality rendering asset can be configured to enable rendering of a watch on a user when utilizing an augmented-reality engine. The order graphical user interface can be provided as part of a customer relationship management platform.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example computing system that performs digital asset generation and registration according to example embodiments of the present disclosure.

FIG. 2 depicts a block diagram of an example design and manufacture process according to example embodiments of the present disclosure.

FIG. 3 depicts a block diagram of an example digital asset factory solution architecture according to example embodiments of the present disclosure.

FIG. 4 depicts a block diagram of an example digital asset factory system according to example embodiments of the present disclosure.

FIG. 5 depicts an illustration of an example user interface according to example embodiments of the present disclosure.

FIG. 6 depicts a flow chart diagram of an example method to perform digital asset design and minting according to example embodiments of the present disclosure.

FIG. 7 depicts a flow chart diagram of an example method to perform digital asset design and minting according to example embodiments of the present disclosure.

FIG. 8 depicts a flow chart diagram of an example method to perform digital asset design and minting according to example embodiments of the present disclosure.

Reference numerals that are repeated across plural figures are intended to identify the same features in various implementations.

### DETAILED DESCRIPTION

### Overview

Generally, the present disclosure is directed to systems and methods for processing one or more inputs, generating a digital asset, and facilitating the minting of the digital asset. In particular, the systems and methods disclosed herein can leverage one or more user interfaces, non-fungible token class indexing, and one or more governances in order to provide an intuitive and effective digital asset factory for generating non-fungible tokens. For example, the systems and methods disclosed herein can include providing an order graphical user interface. The order graphical user interface can include a plurality of entry fields. A minting request can be received via the order graphical user interface. The minting request can include input data input into one or more of the plurality of entry fields. In some implementations, the input data can be descriptive of a digital asset, a quantity, a specific blockchain of a plurality of blockchains, and a cost limit. The cost limit can be descriptive a maximum cost threshold. The systems and methods can include determining a mint cost based at least in part on the quantity and the specific blockchain. Additionally and/or alternatively, the systems and methods can include determining the mint cost is below the maximum cost threshold. The systems and methods can generate one or more tokens. The token can include a script that can be descriptive of a storage location for the digital asset. The one or more tokens can be added to the specific blockchain. In response to adding the one or more tokens to the specific blockchain, the systems and methods can obtain one or more contract addresses associated with the one or more tokens. The one or more contract addresses can be provided as output.

In some implementations, the systems and methods can include providing an initial user interface. The initial user interface can be configured to receive one or more inputs associated with designing the digital asset. Alternatively and/or additionally, the initial user interface can include a catalog of different asset types. In some implementations, the catalog of different asset types can be provided for selection via a drop-down menu, via a plurality of interactive graphical elements, or via other user interface elements. The one or more inputs can include text inputs, selection inputs, audio inputs, and/or image inputs. In some implementations, the catalog of different asset types can include a plurality of different asset types. The plurality of different asset types can include an image asset type, a video asset type, an authentication certificate asset type, an augmented-reality watch asset type, an augmented-reality sneaker asset type, an audio asset type, a text asset type, and/or a virtual-reality asset type.

The systems and methods can receive a product type input. The product type input can include a product type selection associated with a particular product type of a plurality of product types. In some implementations, the systems and methods can obtain a selection of a particular asset type from the catalog of different asset types via the initial user interface. For example, the systems and methods can obtain data descriptive of a selection of the particular asset type in which the selection was a selection of a drop down menu, an interactive graphical element, or a text input matching the particular asset type.

The initial user interface can then be updated based on the product type input. The updated initial user interface can be updated to include one or more new entry fields. Additionally and/or alternatively, the one or more new entry fields can be associated with the digital asset type. In some implementations, the updated initial user interface can include one or more identifiers associated with the product type input (e.g., a digital asset type).

In some implementations, the systems and methods can include generating one or more data files based on the particular product type. The one or more data files can include a text file and an image file. Alternatively and/or additionally, the systems and methods can include obtaining one or more template data files based on the selection. The one or more template data files can be associated with the particular asset type. The one or more template files can be files configured for generating and minting a digital asset of the particular asset type.

Additionally and/or alternatively, the systems and methods can include providing an order graphical user interface. The order graphical user interface can include a plurality of entry fields. The plurality of entry fields can include a blockchain entry field. In some implementations, the blockchain entry field can be configured to receive one or more inputs from the user descriptive of the specific blockchain of the plurality of blockchains. Additionally and/or alternatively, the plurality of entry fields can include a product entry field. The product entry field can be configured to receive one or more inputs from the user descriptive of the digital asset. In some implementations, the plurality of entry fields can include a quantity entry field, and the quantity entry field can be configured to receive one or more inputs from the user descriptive of the quantity.

In some implementations, the order graphical user interface can be provided as part of a customer relationship management platform. Additionally and/or alternatively, the order graphical user interface can be provided as part of a web application. The order graphical user interface configurations can be dependent on the digital asset type.

A minting request can be received via the order graphical user interface. The minting request can include input data input into one or more of the plurality of entry fields. The input data can be descriptive of a digital asset, a quantity, a specific blockchain of a plurality of different blockchains, and/or a cost limit.

The digital asset can include at least one of an authentication certificate, an augmented-reality rendering asset, and/or a virtual-reality asset. In some implementations, the digital asset can include an augmented-reality rendering asset. The augmented-reality rendering asset can be configured to enable rendering of a product (e.g., a watch, sneakers, a shirt, a hat, a purse, and/or jewelry) on a user when utilizing an augmented-reality engine. The digital asset can include an image, a video, text, audio, and/or another form of data. In some implementations, the digital asset can include an authentication certificate that provides a proof of authentication for a physical object. The authentication certificate may be associated with the serial number of the object.

The quantity can be descriptive of a number of non-fungible tokens to mint for that specific digital asset. For example, a user may choose to mint a one of one non-fungible token. Alternatively and/or additionally, the user may choose to mint tens of thousands of non-fungible tokens related to a single digital asset. For example, the digital asset may be an augmented-reality rendering asset for rendering a specific watch. The user can choose to mint six thousand tokens associated with the augmented-reality watch. Therefore, six thousand of the same or similar augmented-reality watches may be provided for sale with each watch having its own respective identification number and each watch may have its own respective ledger on the blockchain.

A specific blockchain can be selected from a list of blockchains of the plurality of different blockchains. The specific blockchain may be selected due to the benefits involved with different blockchains. A user may select a blockchain based on a reputation, a preferred cryptocurrency, a gas price associated with the blockchain, and/or based on a variety of other factors.

The cost limit can be descriptive of a maximum cost threshold. The maximum cost threshold may be set based on individual minting cost and/or may be set based on an overall preferred price for the request. The maximum cost threshold may be based on an allocated budget for the venture as exported from an expense sheet.

In some implementations, a mint cost can be determined based at least in part on the quantity and the specific blockchain. For example, the mint cost can involve obtaining the gas fee for the specific blockchain and/or the transaction fee for such action. The gas fee and/or the transaction fee can be processed with the quantity to determine the overall cost of the minting process.

The mint cost can then be processed to determine whether the mint cost is below the maximum cost threshold. If the mint cost is above the maximum cost threshold, the systems and methods can generate an error notification based on the mint cost being above the maximum cost threshold. The error notification can then be provided via the order graphical user interface. If the mint cost is determined to be below the maximum cost threshold, the systems and methods may continue with the minting process.

The systems and methods can then generate one or more tokens. The token can include a script that can be descriptive of a storage location for the digital asset. In some implementations, the one or more tokens can be generated in response to the mint cost being below the maximum cost threshold.

The one or more tokens can be added to the specific blockchain. Registering the one or more tokens on the specific blockchain can cause a ledger to be generated for the specific token to track the transactions associated with the token.

In response to adding/registering the one or more tokens to the specific blockchain, the systems and methods can obtain one or more contract addresses associated with the one or more tokens. The contract addresses may enable the purchase and/or sale of the specific digital asset by indicating a ledger location for the specific digital asset.

The one or more contract addresses can be provided as an output. The one or more contract addresses can be provided in the order graphical user interface. The contract address may be provided with a cover image for the digital asset. Alternatively and/or additionally, the output may include an output dataset that can be uploaded to a non-fungible token marketplace to allow for the commercial listing of the one or more non-fungible tokens.

In some implementations, the systems and methods disclosed herein can obtain input data via an order graphical user interface. The input data can be descriptive of a digital asset, a specific blockchain of a plurality of blockchains, and a cost limit. The systems and methods can determine a mint cost based at least in part on the specific blockchain. The mint cost can be descriptive of a cost to put a token on the specific blockchain. Additionally and/or alternatively, the systems and methods can determine the mint cost is below a maximum cost threshold. The maximum cost threshold can be associated with the cost limit. The systems and methods can generate a token. The token can be associated with the digital asset. The token can be recorded on the specific blockchain. The systems and methods can include providing the digital asset with a contract address. The contract address can be associated with the token.

For example, the systems and methods can include obtaining, via an order graphical user interface, input data. The input data can be descriptive of a digital asset, a specific blockchain of a plurality of blockchains, and a cost limit. The input data can additionally include quantity data, and the quantity data can be descriptive of a specific number of non-fungible tokens to mint. In some implementations, the digital asset can be associated with loyalty rewards of a loyalty program associated with a specific company. Alternatively and/or additionally, the digital asset may include an authentication certificate, and the authentication certificate can be generated based at least in part on a serial number for a particular physical product.

The systems and methods can determine a mint cost based at least in part on the specific blockchain. The mint cost can be descriptive of a cost to put a token on the specific blockchain. Additionally and/or alternatively, the mint cost may be determined based at least in part on the quantity data, the specific blockchain, and a predicted gas fee.

In some implementations, the systems and methods can include determining the mint cost is below a maximum cost threshold. The maximum cost threshold can be associated with the cost limit.

A token can then be generated. The token can be associated with the digital asset and may include a reference to the digital asset. In some implementations, the token can be a non-fungible token. Additionally and/or alternatively, the token can include a script referencing the digital asset.

The token can then be recorded on the specific blockchain. Recording the specific blockchain can include registering the token with the specific blockchain such that the script of the token is added to the specific blockchain. A ledger can then be associated with the token and the specific digital asset.

The digital asset with a contract address can then be provided. The contract address can be associated with the token. The contract address can be utilized for enabling the sale of the digital asset.

The systems and methods may classify each digital asset into a particular digital asset type or class. The types or classes can include an image type, a video type, an audio type, a watch augmented-reality rendering asset type, a sneaker augmented-reality rendering asset type, an authentication certificate type, etc. The determined or generated classes or types can be associated with a specific data file that can be utilized for designing and minting a digital asset of the specific digital asset type. The data file can include standards associated with the particular digital asset type. In some implementations, the data files can include pre-canned data associated with what the digital asset is (e.g., the data file can include data descriptive of what an augmented-reality watch is and how to utilize the augmented-reality watch).

In some implementations, the systems and methods disclosed herein can provide a user experience that may be analogous to the design and manufacture process of a physical product. The analogous process can make the process more intuitive for companies and creators that are not well-versed in the non-fungible token space: therefore, the systems and methods disclosed herein can provide an entry point for new creators into the marketplace.

Additionally and/or alternatively, the systems and methods disclosed herein can be utilized to make the design and manufacturing of minted non-fungible tokens business ubiquitous and can therefore aid in the progress of Web3. The minted assets may be utilized throughout the digital ecosystem (e.g., in a digital wallet, as a profile picture, in a virtual-reality game, etc.).

In some implementations, the initial user interface and/or the order graphical user interface may include one or more templates for generating a digital asset.

The systems and methods disclosed herein can leverage one or more governances to ensure all request criteria (e.g., the cost limit) is met before the digital asset can be minted.

In some implementations, the systems and methods disclosed herein can be utilized to provide unique brand experiences. The unique brand experiences can include loyalty programs, virtual tickets to virtual experiences, authentication certificates, achievement badges, etc.

The systems and methods disclosed herein may be utilized to provide a non-fungible token manufacturing as a service platform.

A blockchain can be a network where data is stored. The network can be decentralized such that the data may be written in a plurality of locations throughout the network. Additionally and/or alternatively, blockchain automation may utilize smart contracts (e.g., code that executes when certain transactions occur) to provide a ground truth record of transactions for a digital asset. A blockchain may thought of as a database that can be arrayed in multiple redundant nodes in many locations and/or via a network. Additionally and/or alternatively, Web3 can include the practice of using blockchain to accomplish business solutions beyond a data storage method.

Blockchain can be leveraged by smart developers to create what are called “smart contracts.” In some implementations, blockchain can be utilized to maintain a ground truth record of ownership and authenticity for one or more assets (e.g., cryptocurrency ownership or non-fungible token ownership). The purchased asset can then be stored in a digital wallet for future display and use.

The systems and methods disclosed herein can leverage an omnichannel registration portal, a marketing data reporting solution, and a track and trace Engine in order to enable the platform disclosed herein.

In some implementations, the systems and methods can include generating and/or obtaining the data files for minting the specific digital asset type associated with the digital asset. The systems and methods can include embedding the template data files with their respective type and populating any missing data upon the request push, such that the user can be prompted to fill in entry fields that can then be utilized to populate any missing data that may be needed for the minting process.

In some implementations, the systems and methods disclosed herein can be fully automated and/or may be implemented as a partially-automated process.

The systems and methods of the present disclosure provide a number of technical effects and benefits. As one example, the system and methods can provide systems and methods for facilitating the design, manufacture, and minting of a digital asset. For example, the systems and methods disclosed herein can facilitate the design of a digital asset based on one or more selections, can receive a mint request to mint a certain amount of non-fungible tokens, and can register the generated tokens with a specific blockchain of the users choosing. The systems and methods can provide a standardized approach to designing and minting non-fungible tokens related to a variety of different digital asset types.

Another technical benefit of the systems and methods of the present disclosure is the ability to leverage a catalog of template data files to provide minting capabilities to users without experience in minting. For example, the systems and methods disclosed herein can receive a selection of a particular digital asset type and can then obtain one or more data files associated with the digital asset type. The one or more data files can be template data files that can be configured to enable the minting of a specific digital asset of the particular digital asset type.

Another technical benefit of the systems and methods of the present disclosure is the ability to leverage cost governances to ensure a user stays within budget. In particular, the cost governance of the systems and methods disclosed herein can determine a predicted mint cost and determine whether the mint cost is below a user-input cost limit. If the mint cost is below the cost limit, the minting can occur. If the mint cost is above the cost limit, the systems and methods can provide an error notification indicating the inability to follow through with minting with the designated budget.

Another example of technical effect and benefit relates to improved computational efficiency and improvements in the functioning of a computing system. For example, the systems and methods disclosed herein can leverage a database of template data files associated with different digital asset types to quickly and efficiently obtain data files that can be utilized for minting without relying on long, tedious script generation for each new minting. Additionally and/or alternatively, the systems and methods can utilize governances to pre-check requests to ensure an error does not occur during registration of the token on the blockchain.

With reference now to the Figures, example embodiments of the present disclosure will be discussed in further detail.

### Example Devices and Systems

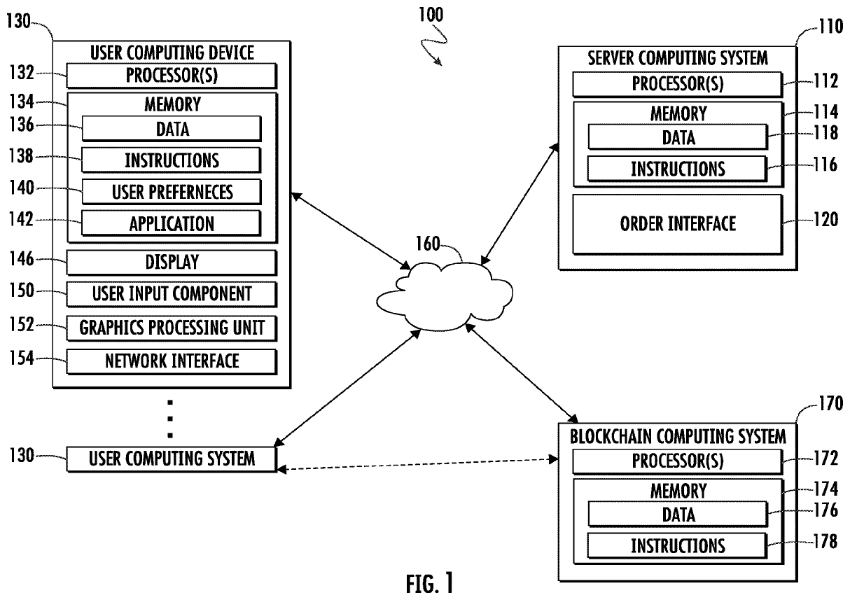

FIG. 1 depicts an exemplary computing system 100 that can be used to implement a digital asset factory platform according to aspects of the present disclosure. The system 100 has a user-server architecture that includes a server 110 that communicates with one or more user computing systems 130 over a network 160. However, the present disclosure can be implemented using other suitable architectures, such as a single computing device unconnected to a network. The system 100 can also have a blockchain computing system 170 to provide a minting platform to a user using the computing system 100.

The system 100 includes a server 110, such as, for example, a web server. The server 110 can be one or more computing devices that are implemented as a parallel or distributed computing system. In particular, multiple computing devices can act together as a single server 110. The server 110 can have one or more processor(s) 112 and a memory 114. The server 110 can also include a network interface used to communicate with one or more remote computing devices (e.g., user computing systems) 130 over a network 160.

The processor(s) 112 can be any suitable processing device, such as a microprocessor, microcontroller, integrated circuit, or other suitable processing device The memory 114 can include any suitable computing system or media, including, but not limited to, non-transitory computer-readable media, RAM, ROM, hard drives, flash drives, or other memory devices. The memory 114 can store information accessible by processor(s) 112, including instructions 116 that can be executed by processor(s) 112. The instructions 116 can be any set of instructions that when executed by the processor(s) 112, cause the processor(s) 112 to provide desired functionality.

In particular, the instructions 116 can be executed by the processor(s) 112 to implement an order interface 120. The order interface 120 can be configured to provide an interface for collecting input data, which can then be utilized to design, manufacture, and mint the non-fungible token. In some implementations, the order interface 120 can be configured to provide instructions to a blockchain computing system 170 to perform a minting service (e.g., adding a script associated with a token to a specific blockchain). In particular, in some implementations, the order interface 120 can be provided for interaction with a user using a user computing system 130 that communicates with the server computing system 110 via a network 160.

It will be appreciated that the term “element” can refer to computer logic utilized to provide desired functionality. Thus, any element, function, and/or instructions can be implemented in hardware, application specific circuits, firmware and/or software controlling a general purpose processor. In one implementation, the elements or functions are program code files stored on the storage device, loaded into memory and executed by a processor or can be provided from computer program products, for example computer executable instructions, that are stored in a tangible computer-readable storage medium such as RAM, hard disk or optical or magnetic media.

Memory 114 can also include data 118 that can be retrieved, manipulated, created, or stored by processor(s) 112. Data 118 can include a data asset factory platform (e.g., a platform for designing, manufacturing, and minting non-fungible tokens). As an example, the data 118 can be used to provide a platform that enables users with minimal blockchain knowledge to generate and mint non-fungible tokens.

The data 118 can be stored in one or more databases. The one or more databases can be connected to the server 110 by a high bandwidth LAN or WAN, or can also be connected to server 110 through a network 160. The one or more databases can be split up so that they are located in multiple locales.

The server 110 can exchange data with one or more user computing systems 130 over the network 160. Although two user computing systems 130 are illustrated in FIG. 1, any number of user computing systems 130 can be connected to the server 110 over the network 160. The user computing systems 130 can be any suitable type of computing device, such as a general purpose computer, special purpose computer, navigational device, laptop, desktop, integrated circuit, mobile device, smartphone, tablet, wearable-computing devices, a display with one or more processors coupled thereto and/or embedded therein, or other suitable computing device. Further, a user computing system 130 can be multiple computing devices acting together to perform operations or computing actions.

Similar to server 110, a user computing system 130 can include a processor(s) 132 and a memory 134. The memory 134 can store information accessible by processor(s) 132, including instructions that can be executed by processor(s) and data. As an example, memory 134 can store a user preferences element 140 and an application element 142.

User preferences element 140 can provide instructions for implementing governances or user preferences. In particular, the user of user computing system 130 can exchange data with server 110 by using the input preferences to populate one or more entry fields of a user interface. The order graphical user interface and the initial user interface of the present disclosure can be provided as an element of a user interface of the website.

Application element 142 can provide instructions for running a specialized application on user computing system 130. In particular, the specialized application can be used to exchange data with server 110 over the network 160. Application element 142 can include client-device-readable code for providing and implementing aspects of the present disclosure. For example, application element 142 can provide instructions for implementing a digital asset factory platform and/or an interface for indexing and classifying digital asset types.

Although FIG. 1 depicts the user preferences element 140 and the application element 142 being stored in the memory 134 of the computing device, in some implementations, the user preferences element 140 and/or the application element 142 may be stored in the memory 114 of the server computing system 110. Additionally and/or alternatively, the server computing system 110 can include a cloud computing system.

The user computing system 130 can include various user input devices 150, or input components, for receiving information from a user, such as a touch screen, touch pad, data entry keys, speakers, mouse, motion sensor, and/or a microphone suitable for voice recognition. In some implementations, the server computing system 110 and the blockchain computing system 170 can include their own input components or may share one or more input components with the user computing system 130, such that a user may be able to provide input for the blockchain computing system 170 using the input devices 150 of the user computing system. Further, the user computing system 130 can have a display 146 for presenting information, such as providing an order interface for third party building. The display 146 can be a visual display including a plurality of visual components for providing the graphical elements of the plate user interface to a user. The visual display can include a liquid crystal display (LCD), a light-emitting diode display (LED), a plasma display, an organic light-emitting diode display (OLED), and/or a cathode ray tube display (CRT).

The user computing system 130 can further include a graphics processing unit 152. Graphics processing unit 152 can be used by processor 132 to provide an intermediary third party interface. In some embodiments, user computing system 130 and/or the server computing system 110 can perform any and all intermediary third party interfaces.

The user computing system 130 can include a network interface 154 for communicating with server 110 over network 160. Network interface 154 can include any components or configuration suitable for communication with server 110 over network 160, including, for example, one or more ports, transmitters, wireless cards, controllers, physical layer components, or other items for communication according to any currently known or future developed communications protocol or technology.

The network 160 can be any type of communications network, such as a local area network (e.g., intranet), wide area network (e.g., Internet), or some combination thereof. The network 160 can also include a direct connection between a user computing system 130 and the server 110. In general, communication between the server 110 and a user computing system 130 can be carried via network interface using any type of wired and/or wireless connection, using a variety of communication protocols (e.g., TCP/IP, HTTP), encodings or formats (e.g., HTML, XML), and/or protection schemes (e.g., VPN, secure HTTP, SSL).

In some implementations, the network 160 can be used to transfer communication between the user computing system 130 and/or the server computing system 110 to the blockchain computing system 170. The communications can be instructions 138 generated in response to an interaction with the server computing system interface to request design and mint a non-fungible token with the digital asset factory platform. For example, the user computing system 130 may receive a plurality of user inputs via the user input component 150 to request a digital asset be manufactured and minted using the order interface 110. Instructions 138 can then be generated that can be interpreted by the blockchain computing system 170 to mint a generated non-fungible token. Moreover, in some implementations, the instructions 138 can be processed by the one or more processors 172 of the blockchain computing system 170 in order to understand the instructions. The instructions can be saved to memory or interpreted into a more native format for the blockchain platform. The blockchain computing system can further include memory components 174 for locally storing data 176 (e.g., token script data, ledgers, etc.) and instructions 178. The stored data 176 can include data specific to the blockchain platform including blockchain specific terminology, extensions, and logs. In some implementations, the stored data 176 can include past instructions, information necessary for interpretation, and/or localized models. The stored instructions 178 can include predetermined functions, user-generated functions, and/or trained functions for various tasks the blockchain computing system can complete. For example, the stored instructions 178 can include a plurality of instructions for executing code in response to a transaction.

In some implementations, one or more non-transitory computer readable media that collectively store instructions that, when executed by the one or more processors, cause the blockchain computing system to perform operations can be included in the computing system. In some implementations, the memory components of the user computing system 130, the server computing system 110, and the blockchain computing system 170 can include the one or more non-transitory computer readable media. The stored instructions can include instructions that cause one or more of the computing systems to perform operations that can include the methods and processes disclosed herein.

In some implementations, one or more of the computing systems can leverage one or more application programming interfaces for automating application interactions. For example, in some implementations, the server computing system 110 may generate and/or store one or more application programming interfaces to facilitate communications with one or more blockchain computing system 170 applications. Moreover, in some implementations, the one or more application programming interface may be generated in response to one or more client interactions via the order interface 120 and/or the network interface 154.

### Example Model Arrangements

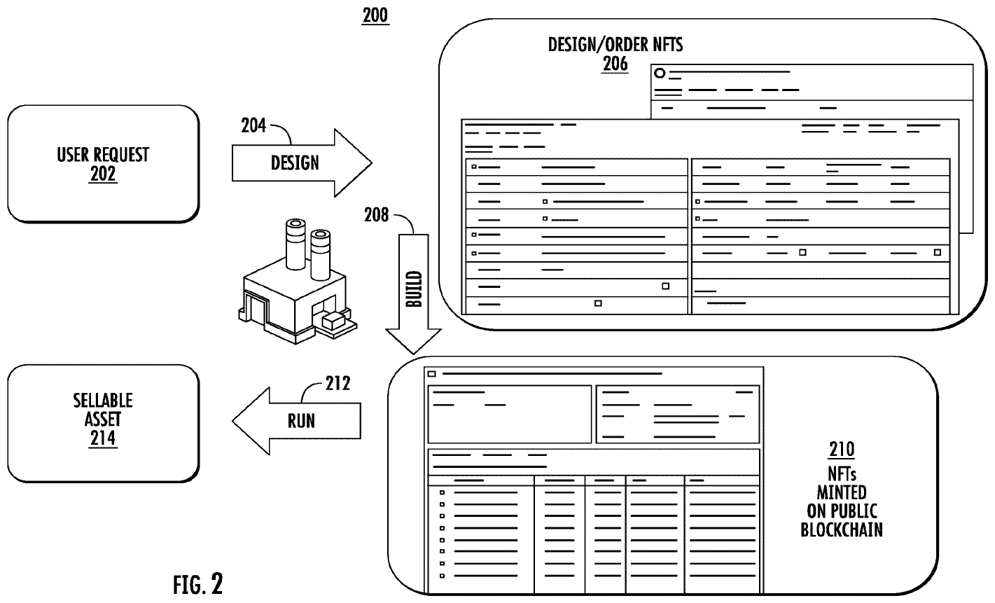

FIG. 2 depicts a block diagram of an example design and manufacture process 200 according to example embodiments of the present disclosure. In some implementations, the design and manufacture process 200 is configured to receive a user request 202 descriptive of a plurality of inputs for designing and minting non-fungible token associated with a digital asset and, as a result of receipt of the user request 202, provide a sellable asset 214 that is a digital asset associated with the non-fungible token. Thus, in some implementations, the design and manufacture process 200 can include designing 204 a digital asset, building 208 the digital asset, and running 212 the generated token to mint the non-fungible token.

In particular, the example design and manufacture process 200 can include obtaining a user request 202 including one or more inputs. The user request 202 can include a request to generate and mint a non-fungible token. The user request 202 can be utilized to design 204 a digital asset. The one or more inputs can be processed to generate a non-fungible token 206. The non-fungible token can then be minted on a public blockchain 210. The contract address can then be obtained. The sellable asset 214 can then be listed for sale with transactions be recorded on the blockchain.

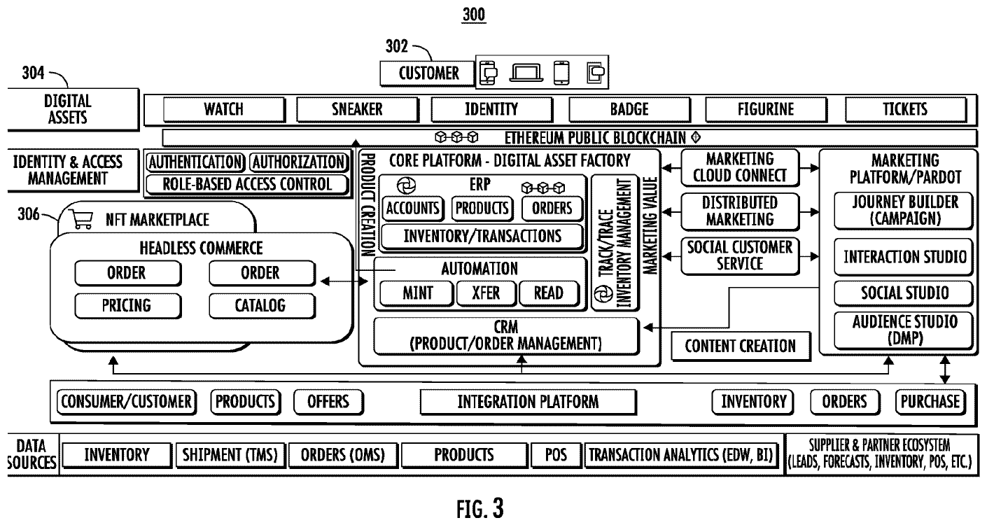

FIG. 3 depicts a block diagram of an example digital asset factory solution architecture 300 according to example embodiments of the present disclosure. The example digital asset factory solution architecture 300 can leverage a plurality of sub-blocks, a plurality of application programming interfaces, and/or a plurality of computing devices. The example digital asset factory solution architecture 300 can be configured to receive mint requests from customers 302 to generate non-fungible tokens associated with digital assets 304. The minted non-fungible tokens can then be listed on a non-fungible token marketplace 306. The customer's request can include a selection of a digital asset type (e.g., watch, sneaker, identity, badge, figurine, tickets, etc.), which can cause one or more data files to be obtained and processed based on the particular digital asset type.

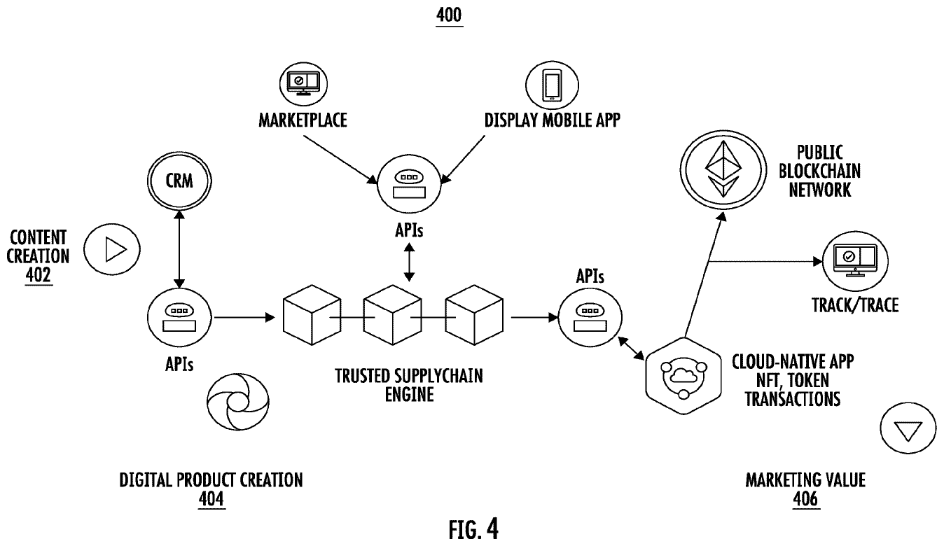

FIG. 4 depicts a block diagram of an example digital asset factory system 400 according to example embodiments of the present disclosure. The digital asset factory 400 can include a content creation block 402. Additionally and/or alternatively, the digital asset factory system 400 can include a digital product creation block 404. In some implementations, the digital asset factory system 400 can include marketing value 406 by intuitively providing a system for generating and minting non-fungible tokens. Additionally and/or alternatively, the digital asset factory system 400 can further include a tracking and tracing block to collect data to be utilized for providing useful information to the users.

The digital asset factory system 400 can provide one or more services (e.g., a hosted digital factory for creating marketing created content service: can leverage public (e.g., Ethereum, Solana, other), private, or hybrid blockchains: can be utilized by custom NFT marketplace portal and mobile apps: can be utilized by an immersive/AR customer mobile app; and a custom marketing data track/trace reporting system).

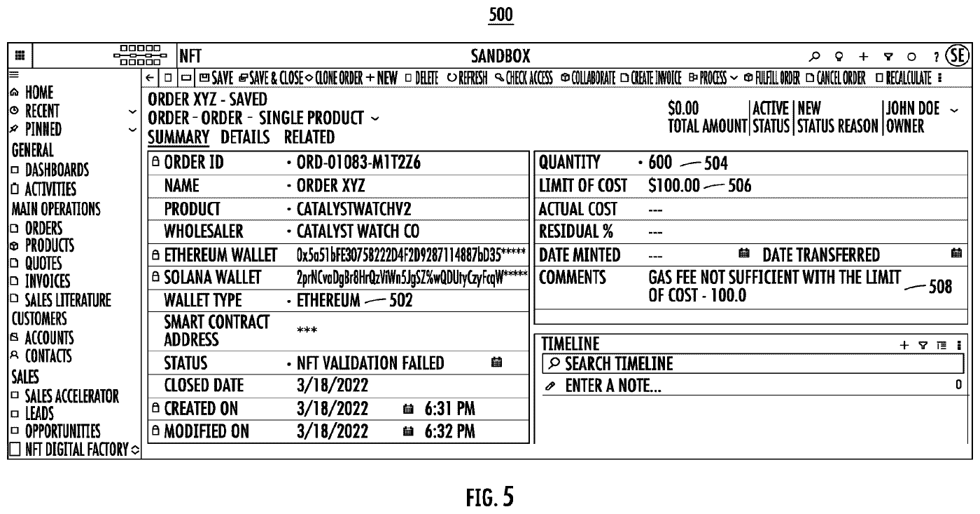

FIG. 5 depicts an illustration of an example user interface 500 according to example embodiments of the present disclosure. In particular, FIG. 5 can depict an example order graphical user interface 500. The order graphical user interface 500 can include a plurality of entry fields. The entry fields can include a wallet entry field 502, a quantity entry field 504, and a cost limit entry field 506. The entered data can then be processed, and the internal governances can determine if the request can be run. In the depicted example, the governance check failed, and an error notification 508 is provided indicating that the requested minting process could not be completed with the input budget.

### Example Methods

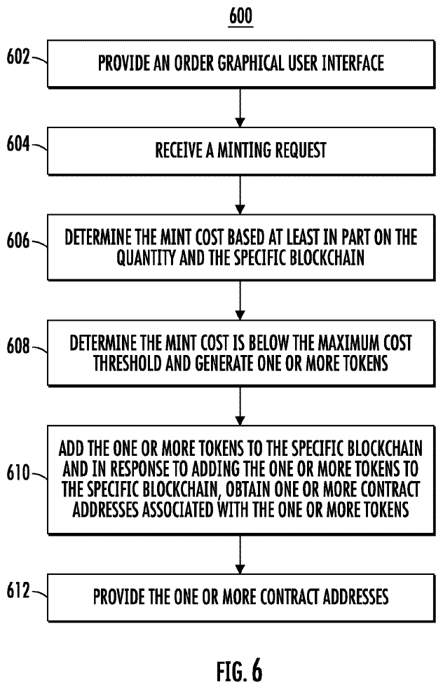

FIG. 6 depicts a flow chart diagram of an example method to perform according to example embodiments of the present disclosure. Although FIG. 6 depicts steps performed in a particular order for purposes of illustration and discussion, the methods of the present disclosure are not limited to the particularly illustrated order or arrangement. The various steps of the method 600 can be omitted, rearranged, combined, and/or adapted in various ways without deviating from the scope of the present disclosure.

At 602, a computing system can provide an order graphical user interface. The order graphical user interface can include a plurality of entry fields. The plurality of entry fields can include a blockchain entry field. In some implementations, the blockchain entry field can be configured to receive one or more inputs from the user descriptive of the specific blockchain of the plurality of blockchains. Additionally and/or alternatively, the plurality of entry fields can include a product entry field. The product entry field can be configured to receive one or more inputs from the user descriptive of the digital asset. In some implementations, the plurality of entry fields can include a quantity entry field, and the quantity entry field can be configured to receive one or more inputs from the user descriptive of the quantity.

In some implementations, the order graphical user interface can be provided as part of a customer relationship management platform. Additionally and/or alternatively, the order graphical user interface can be provided as part of a web application. The order graphical user interface configurations can be dependent on the digital asset type.

At 604, the computing system can receive a minting request. The minting request can be received via the order graphical user interface. The minting request can include input data input into one or more of the plurality of entry fields. The input data can be descriptive of a digital asset, a quantity, a specific blockchain of a plurality of different blockchains, and/or a cost limit.

The digital asset can include at least one of an authentication certificate, an augmented-reality rendering asset, and/or a virtual-reality asset. In some implementations, the digital asset can include an augmented-reality rendering asset. The augmented-reality rendering asset can be configured to enable rendering of a product (e.g., a watch, sneakers, a shirt, a hat, a purse, and/or jewelry) on a user when utilizing an augmented-reality engine. The digital asset can include an image, a video, text, audio, and/or another form of data. In some implementations, the digital asset can include an authentication certificate that provides a proof of authentication for a physical object. The authentication certificate may be associated with the serial number of the object.

The quantity can be descriptive of a number of non-fungible tokens to mint for that specific digital asset. For example, a user may choose to mint a one of one non-fungible token. Alternatively and/or additionally, the user may choose to mint tens of thousands of non-fungible tokens related to a single digital asset. For example, the digital asset may be an augmented-reality rendering asset for rendering a specific watch. The user can choose to mint six thousand of the augmented-reality watch. Therefore, six thousand of the same or similar augmented-reality watches may be provided for sale with each watch having its own respective identification number and each watch may have its own respective ledger on the blockchain.

A specific blockchain can be selected from a list of blockchains of the plurality of different blockchains. The specific blockchain may be selected due to the benefits involved with different blockchains. A user may select a blockchain based on a reputation, a preferred cryptocurrency, a gas price associated with the blockchain, or based on a variety of other factors.

The cost limit can be descriptive of a maximum cost threshold. The maximum cost threshold may be set based on individual minting cost and/or may be set based on an overall preferred price for the request. The maximum cost threshold may be based on an allocated budget for the venture as exported from an expense sheet.

At 606, the computing system can determine a mint cost based at least in part on the quantity and the specific blockchain. For example, the mint cost can involve obtaining the gas fee for the specific blockchain and/or the transaction fee for such action. The gas fee and/or the transaction fee can be processed with the quantity to determine the overall cost of the minting process.

At 608, the computing system can determine the mint cost is below the maximum cost threshold and generate one or more tokens. If the mint cost is above the maximum cost threshold, the systems and methods can generate an error notification based on the mint cost being above the maximum cost threshold. The error notification can then be provided via the order graphical user interface. If the mint cost is determined to be below the maximum cost threshold, the systems and methods may continue with the minting process. The token can include a script that can be descriptive of a storage location for the digital asset. In some implementations, the one or more tokens can be generated in response to the mint cost being below the maximum cost threshold.

At 610, the computing system can add the one or more tokens to the specific blockchain and in response to adding the one or more tokens to the specific blockchain, obtain one or more contract addresses associated with the one or more tokens. Registering the one or more tokens on the specific blockchain can cause a ledger to be generated for the specific token to track the transactions associated with the token. The contract addresses may enable the purchase and/or sale of the specific digital asset by indicating a ledger location for the specific digital asset.

At 612, the computing system can provide the one or more contract addresses. The one or more contract addresses can be provided in the order graphical user interface. The contract address may be provided with a cover image for the digital asset. Alternatively and/or additionally, the output may include a output dataset that can be uploaded to a non-fungible token marketplace to allow for the commercial listing of the one or more non-fungible tokens.

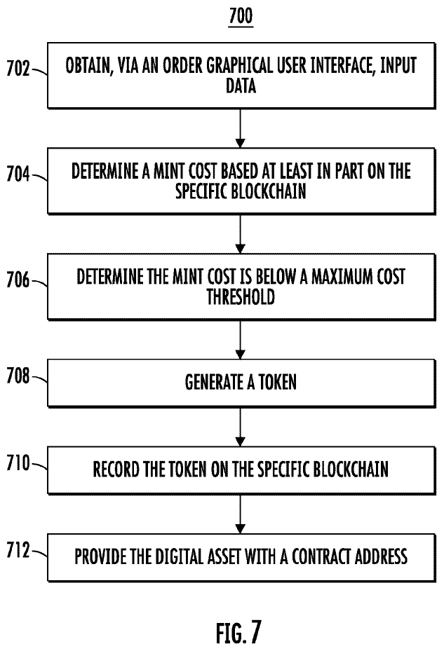

FIG. 7 depicts a flow chart diagram of an example method to perform according to example embodiments of the present disclosure. Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

At 702, a computing system can obtain, via an order graphical user interface, input data. The input data can be descriptive of a digital asset, a specific blockchain of a plurality of blockchains, and a cost limit. The input data can additionally include quantity data, and the quantity data can be descriptive of a specific number of non-fungible tokens to mint. In some implementations, the digital asset can be associated with loyalty rewards of a loyalty program associated with a specific company. Alternatively and/or additionally, the digital asset may include an authentication certificate, and the authentication certificate can be generated based at least in part on a serial number for a particular physical product.

At 704, the computing system can determine a mint cost based at least in part on the specific blockchain. The mint cost can be descriptive of a cost to put a token on the specific blockchain. Additionally and/or alternatively, the mint cost may be determined based at least in part on the quantity data, the specific blockchain, and a predicted gas fee.

At 706, the computing system can determine the mint cost is below a maximum cost threshold. The maximum cost threshold can be associated with the cost limit.

At 708, the computing system can generate a token. The token can be associated with the digital asset and may include a reference to the digital asset. In some implementations, the token can be a non-fungible token. Additionally and/or alternatively, the token can include a script referencing the digital asset.

At 710, the computing system can record the token on the specific blockchain. Recording the specific blockchain can include registering the token with the specific blockchain such that the script of the token is added to the specific blockchain. A ledger can then be associated with the token and the specific digital asset.

At 712, the computing system can provide the digital asset with a contract address. The contract address can be associated with the token. The contract address can be utilized for enabling the sale of the digital asset.

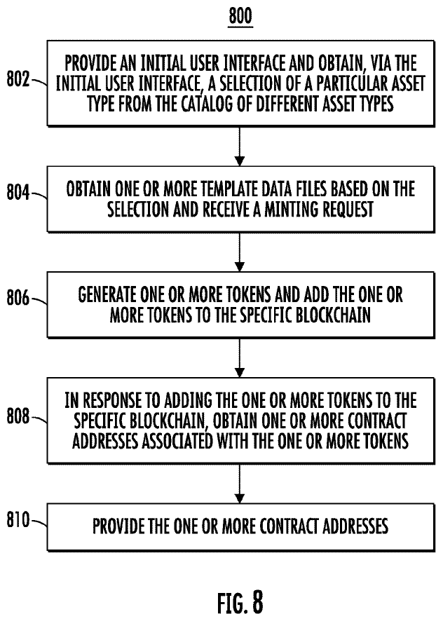

FIG. 8 depicts a flow chart diagram of an example method to perform according to example embodiments of the present disclosure. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

At 802, a computing system can provide an initial user interface and obtain, via the initial user interface, a selection of a particular asset type from the catalog of different asset types. The initial user interface can be configured to receive one or more inputs associated with designing the digital asset. Alternatively and/or additionally, the initial user interface can include a catalog of different asset types. In some implementations, the catalog of different asset types can be provided for selection via a drop-down menu, via a plurality of interactive graphical elements, or via other user interface element. The one or more inputs can include text inputs, selection inputs, audio inputs, and/or image inputs. In some implementations, the catalog of different asset types can include a plurality of different asset types. The plurality of different asset types can include an image asset type, a video asset type, an authentication certificate asset type, an augmented-reality watch asset type, an augmented-reality sneaker asset type, an audio asset type, a text asset type, and/or a virtual-reality asset type.

At 804, the computing system can obtain one or more template data files based on the selection and receive a minting request. The one or more template data files can be associated with the particular asset type. The one or more template files can be files configured for generating and minting a digital asset of the particular asset type. The minting request can include input data input into one or more of the plurality of entry fields. The input data can be descriptive of a digital asset, a quantity, a specific blockchain of a plurality of different blockchains, and/or a cost limit.

The digital asset can include at least one of an authentication certificate, an augmented-reality rendering asset, and/or a virtual-reality asset. In some implementations, the digital asset can include an augmented-reality rendering asset. The augmented-reality rendering asset can be configured to enable rendering of a product (e.g., a watch, sneakers, a shirt, a hat, a purse, and/or jewelry) on a user when utilizing an augmented-reality engine. The digital asset can include an image, a video, text, audio, and/or another form of data. In some implementations, the digital asset can include an authentication certificate that provides a proof of authentication for a physical object. The authentication certificate may be associated with the serial number of the object.

The quantity can be descriptive of a number of non-fungible tokens to mint for that specific digital asset. For example, a user may choose to mint a one of one non-fungible token. Alternatively and/or additionally, the user may choose to mint tens of thousands of non-fungible tokens related to a single digital asset. For example, the digital asset may be an augmented-reality rendering asset for rendering a specific watch. The user can choose to mint six thousand of the augmented-reality watch. Therefore, six thousand of the same or similar augmented-reality watches may be provided for sale with each watch having its own respective identification number and each watch may have its own respective ledger on the blockchain.

A specific blockchain can be selected from a list of blockchains of the plurality of different blockchains. The specific blockchain may be selected due to the benefits involved with different blockchains. A user may select a blockchain based on a reputation, a preferred cryptocurrency, a gas price associated with the blockchain, or based on a variety of other factors.

At 806, the computing system can generate one or more tokens and add the one or more tokens to the specific blockchain. The token can include a script that can be descriptive of a storage location for the digital asset. In some implementations, the one or more tokens can be generated in response to the mint cost being below the maximum cost threshold. Registering the one or more tokens on the specific blockchain can cause a ledger to be generated for the specific token to track the transactions associated with the token.

At 808, the computing system can obtain one or more contract addresses associated with the one or more tokens in response to adding the one or more tokens to the specific blockchain. The contract addresses may enable the purchase and/or sale of the specific digital asset by indicating a ledger location for the specific digital asset.

At 810, the computing system can provide the one or more contract addresses. The one or more contract addresses can be provided in the order graphical user interface. The contract address may be provided with a cover image for the digital asset. Alternatively and/or additionally, the output may include a output dataset that can be uploaded to a non-fungible token marketplace to allow for the commercial listing of the one or more non-fungible tokens.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computing system for requesting digital asset generation, the system comprising:
one or more processor; and
one or more non-transitory computer-readable media that collectively store instructions that, when executed by the one or more processors, cause the computing system to perform operations, the operations, comprising:
providing an order graphical user interface, wherein the order graphical user interface comprises a plurality of entry fields;
receiving, via the order graphical user interface, a minting request, wherein the minting request comprises input data input into one or more of the plurality of entry fields, wherein the input data is descriptive of:
a digital asset;
a quantity;
a specific blockchain of a plurality of blockchains; and
a cost limit, wherein the cost limit is descriptive a maximum cost threshold;
determining a mint cost based at least in part on the quantity and the specific blockchain;
determining the mint cost is below the maximum cost threshold;
generating one or more tokens, wherein the token comprises a script that is descriptive of a storage location for the digital asset;
adding the one or more tokens to the specific blockchain;
in response to adding the one or more tokens to the specific blockchain, obtaining one or more contract addresses associated with the one or more tokens; and
providing the one or more contract addresses.

2. The system of claim 1, wherein the operations further comprise:
providing an initial user interface, wherein the initial user interface is configured to receive one or more inputs associated with designing the digital asset.

3. The system of claim 2, wherein the operations further comprise:
receiving a product type input, wherein the product type input comprises a product type selection associated with a particular product type of a plurality of product types.

4. The system of claim 3, wherein the operations further comprise:
updating the initial user interface based on the product type input; and
generating one or more data files based on the particular product type.

5. The system of claim 4, wherein the one or more data files comprise a text file and an image file.

6. The system of claim 1, wherein the digital asset comprises at least one of an authentication certificate, an augmented-reality rendering asset, or a virtual-reality asset.

7. The system of claim 1, wherein the plurality of entry fields comprises a blockchain entry field, wherein the blockchain entry field is configured to receive one or more inputs from the user descriptive of the specific blockchain of the plurality of blockchains.

8. The system of claim 1, wherein the plurality of entry fields comprises a product entry field, wherein the product entry field is configured to receive one or more inputs from the user descriptive of the digital asset.

9. The system of claim 1, wherein the plurality of entry fields comprises a quantity entry field, wherein the quantity entry field is configured to receive one or more inputs from the user descriptive of the quantity.

10. A computer-implemented method for minting digital assets, the method comprising:
obtaining, via an order graphical user interface and by a computing system comprising one or more processors, input data, wherein the input data is descriptive of: a digital asset, a specific blockchain of a plurality of blockchains, and a cost limit;
determining, by the computing system, a mint cost based at least in part on the specific blockchain, wherein the mint cost is descriptive of a cost to put a token on the specific blockchain;
determining, by the computing system, the mint cost is below a maximum cost threshold, wherein the maximum cost threshold is associated with the cost limit;
generating, by the computing system, a token, wherein the token is associated with the digital asset;
recording, by the computing system, the token on the specific blockchain; and
providing, by the computing system, the digital asset with a contract address, wherein the contract address is associated with the token.

11. The method of claim 10, wherein the input data comprises quantity data, wherein the quantity data is descriptive of a specific number of non-fungible tokens to mint.

12. The method of claim 11, wherein the mint cost is determined based on the quantity data, the specific blockchain, and a predicted gas fee.

13. The method of claim 10, wherein the token is a non-fungible token, and wherein the token comprises a script referencing the digital asset.

14. The method of claim 10, wherein the digital asset is associated with loyalty rewards of a loyalty program associated with a specific company.

15. The method of claim 10, wherein the digital asset comprises an authentication certificate, wherein the authentication certificate is generated based at least in part on a serial number for a particular physical product.

16. One or more non-transitory computer-readable media that collectively store instructions that, when executed by one or more computing devices, cause the one or more computing devices to perform operations, the operations comprising:
providing an initial user interface, wherein the initial user interface comprises a catalog of different asset types;
obtaining, via the initial user interface, a selection of a particular asset type from the catalog of different asset types;
obtaining one or more template data files based on the selection, wherein the one or more template data files are associated with the particular asset type;
receiving a minting request, wherein the minting request comprises input data input into an order graphical user interface, wherein the input data is descriptive of:
a digital asset;
a quantity; and
a specific blockchain of a plurality of blockchains;
generating one or more tokens based at least in part on the one or more template data files and the input data, wherein the token comprises a script that is descriptive of a storage location for the digital asset;
adding the one or more tokens to the specific blockchain;
in response to adding the one or more tokens to the specific blockchain, obtaining one or more contract addresses associated with the one or more tokens; and
providing the one or more contract addresses.

17. The one or more non-transitory computer-readable media of claim 16, wherein the input data comprises a cost limit, wherein the cost limit is descriptive a maximum cost threshold; and
wherein the operations further comprise:
determining a mint cost based at least in part on the quantity and the specific blockchain;
determining the mint cost is below the maximum cost threshold; and
wherein the one or more tokens are generated in response to the mint cost being below the maximum cost threshold.

18. The one or more non-transitory computer-readable media of claim 16, wherein the input data comprises a cost limit, wherein the cost limit is descriptive a maximum cost threshold; and
wherein the operations further comprise:
determining a mint cost based at least in part on the quantity and the specific blockchain;
determining the mint cost is above the maximum cost threshold;
generating an error notification based on the mint cost being above the maximum cost threshold; and
providing, via the order graphical user interface, the error notification.

19. The one or more non-transitory computer-readable media of claim 16, wherein the digital asset comprises an augmented-reality rendering asset, wherein the augmented-reality rendering asset is configured to enable rendering of a watch on a user when utilizing an augmented-reality engine.

20. The one or more non-transitory computer-readable media of claim 16, wherein the order graphical user interface is provided as part of a customer relationship management platform.
